(19) United States
(12) Patent Application Publication
(10) Pub. No.: US 2006/0193503 A1
(43) Pub. Date: Aug. 31, 2006

(54) Method and apparatus for enhanced security in biometric systems

(75) Inventor: Roger A. Bauchspies, San Mateo, CA (US)

Correspondence Address: MICHAEL E. WOODS;PATENT LAW OFFICES OF MICHAEL E. WOODS, 112 BARN ROAD, TIBURON, CA, 94920-2602, US

(73) Assignee: ODI SECURITY; LLC, Mountain View, CA (US)

(21) Appl. No.: 11/162,398

(22) Filed: Sep. 8, 2005

Related U.S. Application Data
(60) Provisional application No. 60/611,238, filed on Sep. 17, 2004.

(51) Int. Cl. G06K 9/00

(52) U.S. Cl. 382/124

(57) ABSTRACT

A method including attempting a match of a series of sample biometric signatures into a database having one or more valid biometric signatures; accumulating a first number N1 of consecutive failed match attempts prior to a successful match wherein a failed match attempt occurs when one of the sample biometric signatures does not match any of the valid biometric signatures; comparing the first number N1 and the second number N2 to a predetermined threshold value M for a match comparison; validating a successful match when the comparing feat determines the first number N1 and the second number N2 both have a particular relationship to the predetermined threshold value M; and recording a second number N2 equal to the value of the first number N1 when a sample biometric signature matches one of the valid biometric signatures.

### BACKGROUND OF THE INVENTION

The present invention relates generally to automatic machine-implemented fingerprint recognition systems, and more specifically to a system, method, computer program product, and propagated signal for efficiently assembling a complete biometric pattern using a senor having a limited field-of-view.

The use of biometrics as an aid to confirming authorization for access to various types of resources or locations has been increasing. Biometric systems measure various unique or nearly unique characteristics of a person's body to assist in confirming identity, and consequently in authorizing an access requested by the person. Common body characteristics used in these systems include fingerprints and eye retinal patterns.

Fingerprints are believed by many to be unique or nearly unique across the population base. Fingerprints include ridges/furrows that define a complex pattern. Each fingerprint typically includes many pattern features (including features referred to as minutia) that are cognizable by detection systems. These minutia serve as the basis by which many fingerprint biometric systems judge a match between a fingerprint-under-test and a reference fingerprint. That is, when the system determines that there is a sufficient match between the fingerprint-under-test and the reference, the system has determined that there are enough matching minutia between the two.

Statistically, many conventional biometrics systems strive for one false acceptance in one thousand tests (False Acceptance Rate or “FAR”) or higher security level. Because of the flexible nature of many biometric signature sources (e.g., the finger with a fingerprint) and the inability of the source to be identically positioned relative to an image capture device, it is possible for a non-registered user to be falsely matched with enough attempts by querying a system database with sufficient frequency.

What is needed is a biometrics system that offers improved accuracy and processing efficiency to enhance security.

### BRIEF SUMMARY OF THE INVENTION

Disclosed are an apparatus, system, computer program product, and propagated signal for a fingerprint acquisition system. The method includes: attempting a match of a series of sample biometric signatures into a database having one or more valid biometric signatures; accumulating a first number N1 of consecutive failed match attempts prior to a successful match wherein a failed match attempt occurs when one of the sample biometric signatures does not match any of the valid biometric signatures; comparing the first number N1 and the second number N2 to a predetermined threshold value M for a match comparison; recording a second number N2 equal to the value of the first number N1 and setting the first number N1 to zero when a sample biometric signature matches one of the valid biometric signatures; and validating a successful match when the comparing feat (d) determines the first number N1 and the second number N2 both have a particular relationship to the predetermined threshold value M. A computer program product includes a computer readable medium carrying program instructions for validating a biometric signature when executed using a computing system, the executed program instructions executing the method described above. A propagated signal on which is carried computer-executable instructions which when executed by a computing system also performs this method.

An alternate preferred embodiment of the present invention includes an apparatus. The apparatus includes an imager for receiving a series of sample biometric signatures; and a processor, coupled to the imager, for: attempting a match of a series of sample biometric signatures into a database having one or more valid biometric signatures; accumulating a first number N1 of consecutive failed match attempts prior to a successful match wherein a failed match attempt occurs when one of the sample biometric signatures does not match any of the valid biometric signatures; comparing the first number N1 and the second number N2 to a predetermined threshold value M for a match comparison; recording a second number N2 equal to the value of the first number N1 and setting the first number N1 to zero when a sample biometric signature matches one of the valid biometric signatures; and validating a successful match when the comparing feat (d) determines the first number N1 and the second number N2 both have a particular relationship to the predetermined threshold value M.

The novel features which are characteristic of the invention, as to organization and method of operation, together with further objects and advantages thereof, will be better understood from the following description considered in connection with the accompanying drawings in which one or more preferred embodiments of the invention are illustrated by way of example. It is to be expressly understood, however, that the drawings are for the purpose of illustration and description only and are not intended as a definition of the limits of the invention. These drawings include the following figures, with like numerals indicating like parts.

### BRIEF DESCRIPTION OF THE DRAWINGS

FIG. 1 is a block schematic diagram of a preferred embodiment for a biometric validation system; and

FIG. 2 is a process flow diagram of an operational flow implemented by the biometric validation system shown in FIG. 1.

### DETAILED DESCRIPTION OF THE INVENTION

The present invention relates to a biometric validation system that offers improved accuracy and processing efficiency while enhancing security. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

For purposes of the present discussion of a biometric signature validation process in which a biometric signature-under-test (e.g., a fingerprint) is compared against a set of candidate signatures, with a comparison signal produced based upon the results of any comparisons, the term fingerprint is taken in its broadest sense. Fingerprint includes a map of contrasting amplitude element and as such, the ridge/furrow pattern on human fingers is included as a fingerprint. Additionally, zebra stripe patterns, retinal vein patterns, or other map of contrasting elements having sufficiently long elements and points of interest coupled to these elements. Biometric signatures are produced from biometric objects and include, in a broad sense, user unique characteristics measurable by a sensing apparatus. For example, in addition to the broad sense of “fingerprint” described above, biometric objects include vocal chords generating a vocal signature and a user-controlled writing implement/stylus generating a handwriting signature and other user-unique attributes.

Also, to simplify the present discussion, the discussion will emphasize how to make and use, as well as the best mode, of a validation engine/process for use in an embedded system. The nature, type and implementation details of the embedded system are not discussed in much detail as the preferred embodiment may be adapted for use in a very wide range of systems. The embedded system determines when to test a biometric signature, how to reconstruct a biometric signature using a limited field-of-view sensor, when to write/remove reference biometric signatures into/from nonvolatile memory, what level of correspondence between a test biometric signature and a reference biometric signature is required for a “match,” and what happens with a comparison signal produced from the system when a biometric signature matches a particular reference biometric signature. In a simple implementation, the preferred embodiment returns a valid match signal when a particular biometric signature under test generates a match given a state of previous pass/fail attempts.

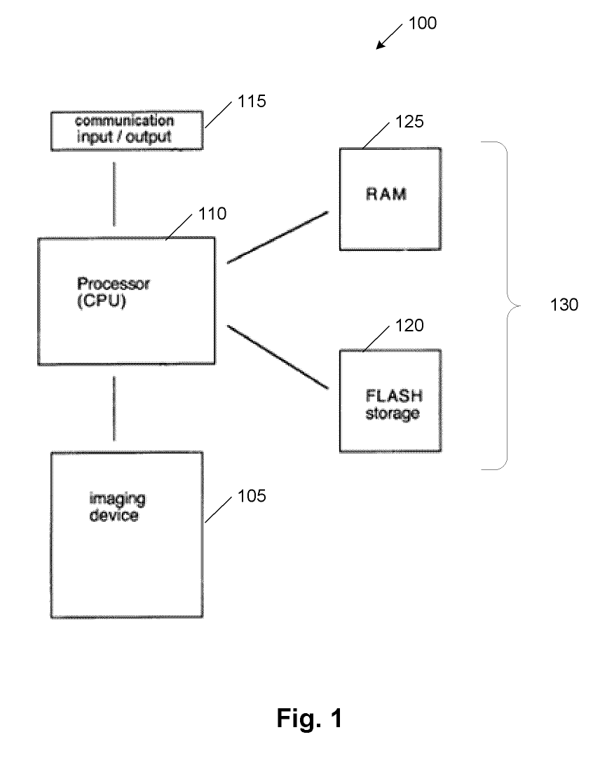

FIG. 1 is a block schematic diagram of a preferred embodiment for a validation system 100. System 100 includes an imaging device 105, a processor 110, an input/output (I/O) system 115, a nonvolatile memory 120 and a RAM memory 125, with memory 120 and memory 125 collectively defining a memory system 130. System 100 is described, in the preferred embodiment, as fingerprint verification system as opposed to other type of fingerprint checking/matching system. In a fingerprint verification system, the system attempts to measure a correspondence between a test fingerprint and reference fingerprints (one-on-one) in order to confirm identify of the test to the reference database. This is contrasted with an identification system that determines which reference the test has been matched to. Typically, a verification system may be used as an identification system if a decrease in power/speed is acceptable, given analogous resources.

System 100 may function as a basic computer in implementing the present invention for accessing and processing fingerprints, fingerprint images, and ridge maps as further described below. Processor 110 may include one or more central processing units (CPUs), such as one of the PC microprocessors or workstations, e.g. RISC System/6000 (RS/6000) (RISC System/6000 is a trademark of International Business Machines Corporation) series available from International Business Machines Corporation (IBM), is provided and interconnected to various other components, such as by a system bus.

Imaging device 105 is a sensor producing data from a succession of test biometric signatures as a biometric object (e.g., a human finger) is placed in/moved relative a field-of-view of the sensor; either directly (i.e., it is a sensor or imager) or it accesses a data structure or memory to obtain the image. Image in the present context is used in a broad sense to include not just a representation of visual elements, but also digital representations of other elements that collectively define a biometric signature. System 100 in this configuration does not directly address resources and processes for controlling the capture of the successive data sets as well as resources and processes for reconstructing/producing biometric signatures from the successive sets of data. The present invention deals principally with the validation of a candidate match from succession of sets of data. There are many different types of sensors that may be used with system 100 as imager 105 including charge-coupled devices (CCD), complementary metal oxide semiconductor (CMOS), capacitive, or other image sensing devices, such as those available from Fujitsu, Atmel, Authentec, ST Micro, for example. Image arrays may be relatively small (e.g., 128×128 pixels to a more common CIF size of 352×288 pixels or larger), each pixel having a pixel depth of but not limited to eight bits but for purposes of the present invention, the imaging device does not produce a complete image of a biometric object in a single capture frame. In the preferred embodiment, the biometric object is a finger having a fingerprint that is moved relative to device 105.

An operating system runs on processor 110, providing control and coordinating the functions of the various components of the system. The operating system may be one of the commercially available operating systems such as the AIX 6000 operating system or OS/2 operating system available from IBM (AIX 6000 and OS/2 are trademarks of IBM); Microsoft's Windows, Apple's MacOS, as well as UNIX and AIX operating systems, though the preferred embodiment uses a custom control for providing minimal, tailored functions. Custom programs, controlled by the system, are moved into and out of memory. These programs include the program of the present invention to be subsequently described in combination with analyzing and comparing fingerprint-related data. Imager 105, I/O communication system 115, and memory system 130 is coupled to processor 110 via a bus and with memory system 130 including a Basic Input/Output System (BIOS) for controlling the basic system functions.

I/O system 115 interconnects system 100 with outside devices or networks, enabling the system to communicate with other such systems over a communications system (e.g., directly wired, Local Area Network (LAN) or Wide Area Network (WAN), which includes, for example, the Internet, the WEB, intranets, extranets, and other public and private networks, wired, optical, or wireless). The terms associated with the communications system are meant to be generally interchangeable and are so used in the present description of the distribution network. I/O devices are also connected to the system bus via I/O system 115. A keyboard, a pointing device (e.g., mouse, trackball or other device) and a display or indicator may be interconnected to system 100 through I/O system 115. It is through such input devices that the user may interactively relate to the programs for manipulating the resources, images, subsystems, processes and system according to the present invention. By using the aforementioned I/O devices, a user is capable of inputting information to the system through the keyboard or mouse and receiving output information from the system. The system may contain a removable memory component for transferring images, maps, instructions or programs.

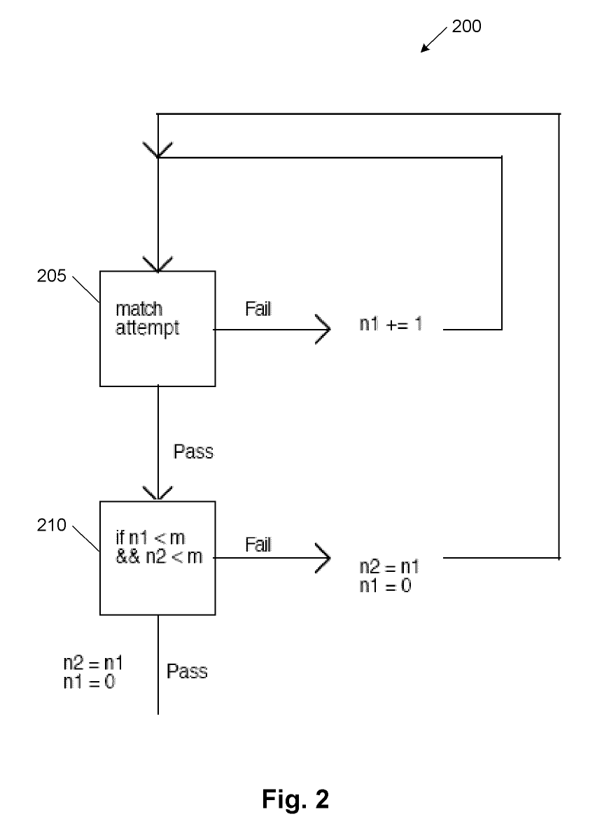

FIG. 2 is a process flow diagram of an operational flow 200 implemented by the biometric validation system shown in FIG. 1. Flow 200 includes a match attempt step 205 and a validation test step 210. Step 205 tests whether a candidate biometric signature produced from imager 105 matches any of a set of valid biometric signatures stored in system 100. When no match is found (a fail), a first number N1 is incremented and a next candidate biometric signature is processed at step 205 some time later. As long as the attempt fails, flow 200 continues to increment N1 and wait to process a next candidate biometric signature when available.

Once a match is found, validation test step 210 is performed following step 205 rather than incrementing first number N1 and looping for a next candidate biometric signature. Test 210 compares first number N1 to a threshold value M and compares a second number N2 to the threshold value M. In the preferred embodiment, test 210 determines whether first number N1 and second number N2 are both less than the threshold value M. When either value exceeds the threshold value M, flow 200 sets second number N2 equal to first number N1 and sets the first number N1 equal to zero and then returns to process a next candidate biometric signature. Note that step 210 did not validate the match found at step 205 that advanced flow 200 to step 210 because of the test results.

However, in the event that both first number N1 and second number N2 both bear the requisite relationship to the threshold value M, step 210 validates the match signal (the biometric signature generates a pass) and flow 200 sets second number N2 equal to first number N1 and sets the first number N1 equal to zero and then returns to process a next candidate biometric signature.

Flow 200 initializes first number N1 and second number N2 to zero for a one-time initial startup value. Thereafter, the first number N1 and second number N2 are written to non-volatile memory and continually reflect a state of the last successive pass/fail attempts as reflected in the values of N1 and N2. The preferred embodiment uses values for M in a range of 4 to 12, though other implementations may use other values appropriate for the system and the level of security to be achieved.

Implementing flow 200 that counts the number of consecutive attempts at matching into a database without success and allowing a successful activation of a locking device/validating a match only when a number of successive failed non-matches is less than the threshold value M. To allow an authorized user entry, in normal operation there would be expected to be continuous matches of the input finger into the database, with authorized users perceiving no different operation.

When a previous X number of attempts were failed match attempts while an X+1 attempt matched into the database, with X exceeding the threshold value M, a second match must be repeated within M attempts to activate the locking mechanism/validate the match. This means to match a finger into an existing database requires a successful match within the last N1 attempts and within the previous N2 attempts before that. As long as successful matches are made in less than M attempts, any user will not notice any difference in operation requiring only one successful match to activate the lock. When more than M attempts are made and not matched, a user interface LED or indicator (visual/aural/tactile, etc.) is used to communicate to the user both that excessive false attempts have been made at matching into the database and that two matches within the M attempts are required to successfully activate the locking mechanism.

A significant increase in security is achieved with little or no inconvenience to authorized user while unauthorized users face a difficult time at falsely entering the system. System 100 of the preferred embodiment does not distinguish users. Any match from any USER is a match, just as any fail from any USER is a fail. A goal of the present invention is to limit is non-registered users repeatedly attempting to gain entry on the 1 in 1000 (or other FAR) statistical chance they would match into the database.

One base premise for system 100 is that a registered user should match within several attempts no matter how badly they apply themselves but a non registered user will have a large number (>m) of bad matches before that 1 in 1000 occurrence. So the N values are the number of attempts between successful openings from any user.

System 100 enhances security without inconveniencing the rightful (registered) user. It is targeted at stopping an unregistered (and potentially malicious user) that is willing to attempt the 1000 false matches in hopes one attempt will eventually match (which statistically it will given enough attempts). Although the unregistered user may match 1 in 1000, the unregistered user has a reduced chance of matching twice within M attempts. It is possible that the unregistered user matches in less than M attempts even though unregistered. Again, this will happen statistically but the unregistered user, statistically, will not be able to repeat it or register in with a system requiring successive valid matches for registration/access. In some implementations, it is possible to add one or more additional steps 210 to get three or more good matches within a threshold. Additionally, M does not have to be the same for the N1 test as it is for the N2 test. However, these additions complicate the testing and the validation beyond the simple and efficient implementation shown and described herein.

Although embodiments of the invention have been described primarily with respect to a fingerprint verification system, any type of fingerprint analysis system may benefit from features of the invention. Other image comparison/processing products such as, for example, retinal scans and machine vision, etc., may similarly benefit from features of the invention.

The biometrics system, method, computer program product, and propagated signal described in this application may, of course, be embodied in hardware; e.g., within or coupled to a Central Processing Unit (“CPU”), microprocessor, microcontroller, System on Chip (“SOC”), or any other programmable device. Additionally, the biometrics system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A biometrics system, method, computer program product, and propagated signal embodied in software may be included in a semiconductor intellectual property core (e.g., embodied in HDL) and transformed to hardware in the production of integrated circuits. Additionally, a biometrics system, method, computer program product, and propagated signal as described herein may be embodied as a combination of hardware and software.

One of the preferred implementations of the present invention is as a routine in an operating system made up of programming steps or instructions resident in a memory of a computing system shown in FIG. 1, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, C#, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A biometric signature acquisition method, the method comprising:
(a) accumulating a first number N1 of consecutive failed attempts at matching a test biometric signature into a database of validated biometric signatures wherein a successful match attempt produces a valid match signal;
(b) comparing said first number N1 to a first threshold value; and
(c) inhibiting any test biometric signature from producing said valid match signal when said first number N1 has a predetermined relationship to said first threshold value.

2. The method of claim 1 further comprising:
(d) accumulating a second number N2 of consecutive failed attempts at matching a test biometric signature into said database following a successful match of a previous test biometric signature;
(e) comparing said second number N2 to a second threshold value; and
(f) reenabling production of said valid match signal when said second number N2 has a predetermined relationship to said second threshold value.

3. The method of claim 2 wherein said first threshold value and said second threshold value are equal.

4. A biometric signature acquisition method, the method comprising:
(a) accumulating a first number N1 of consecutive failed attempts at matching a test biometric signature into a database of validated biometric signatures wherein a successful match attempt produces a valid match signal;
(b) comparing said first number N1 to a first threshold value; and
(c) enabling production of said valid match signal as long as said first number N1 has a predetermined relationship to said first threshold value.

5. The method of claim 4 further comprising:
(d) accumulating a second number N2 of consecutive failed attempts at matching a test biometric signature into said database following an unsuccessful match of a previous test biometric signature;
(e) comparing said second number N2 to a second threshold value; and
(f) inhibiting production of said valid match signal when said second number N2 has a predetermined relationship to said second threshold value.

6. A method, the method comprising:
(a) attempting a match of a series of sample biometric signatures into a database having one or more valid biometric signatures;
(b) accumulating a first number N1 of consecutive failed match attempts prior to a successful match wherein a failed match attempt occurs when one of said sample biometric signatures does not match any of said valid biometric signatures;
(c) recording a second number N2 equal to said value of said first number N1 when a sample biometric signature matches one of said valid biometric signatures;
(d) comparing said first number N1 and said second number N2 to a predetermined threshold value M for a match comparison; and
(e) validating a successful match when said comparing feat (d) determines said first number N1 and said second number N2 both have a particular relationship to said predetermined threshold value M.

7. The method of claim 6 wherein said comparing feat (d) sets said second number N2 equal to said first number N1 and thereafter sets said first number N1 equal to zero after said match comparison.

8. A computer program product including a computer readable medium carrying program instructions for validating a test biometric signature when executed using a computing system, the executed program instructions executing a method, the method comprising:
(a) attempting a match of a series of sample biometric signatures into a database having one or more valid biometric signatures;
(b) accumulating a first number N1 of consecutive failed match attempts prior to a successful match wherein a failed match attempt occurs when one of said sample biometric signatures does not match any of said valid biometric signatures;
(c) recording a second number N2 equal to said value of said first number N1 when a sample biometric signature matches one of said valid biometric signatures;
(d) comparing said first number N1 and said second number N2 to a predetermined threshold value M for a match comparison; and
(e) validating a successful match when said comparing feat (d) determines said first number N1 and said second number N2 both have a particular relationship to said predetermined threshold value M.

9. A propagated signal on which is carried computer-executable instructions which when executed by a computing system performs a method, the method comprising:
(a) attempting a match of a series of sample biometric signatures into a database having one or more valid biometric signatures;
(b) accumulating a first number N1 of consecutive failed match attempts prior to a successful match wherein a failed match attempt occurs when one of said sample biometric signatures does not match any of said valid biometric signatures;
(c) recording a second number N2 equal to said value of said first number N1 when a sample biometric signature matches one of said valid biometric signatures;
(d) comparing said first number N1 and said second number N2 to a predetermined threshold value M for a match comparison; and
(e) validating a successful match when said comparing feat (d) determines said first number N1 and said second number N2 both have a particular relationship to said predetermined threshold value M.

10. An apparatus, comprising:
an imager for receiving a series of sample biometric signatures; and
a processor, coupled to said imager, for:
attempting a match of a series of sample biometric signatures into a database having one or more valid biometric signatures;
accumulating a first number N1 of consecutive failed match attempts prior to a successful match wherein a failed match attempt occurs when one of said sample biometric signatures does not match any of said valid biometric signatures;
recording a second number N2 equal to said value of said first number N1 when a sample biometric signature matches one of said valid biometric signatures;
comparing said first number N1 and said second number N2 to a predetermined threshold value M for a match comparison; and
validating a successful match when said comparing feat (d) determines said first number N1 and said second number N2 both have a particular relationship to said predetermined threshold value M.

11. An apparatus, comprising:
means for attempting a match of a series of sample biometric signatures into a database having one or more valid biometric signatures;
means for accumulating a first number N1 of consecutive failed match attempts prior to a successful match wherein a failed match attempt occurs when one of said sample biometric signatures does not match any of said valid biometric signatures;
means for recording a second number N2 equal to said value of said first number N1 when a sample biometric signature matches one of said valid biometric signatures;
means for comparing said first number N1 and said second number N2 to a predetermined threshold value M for a match comparison; and
means for validating a successful match when said comparing feat (d) determines said first number N1 and said second number N2 both have a particular relationship to said predetermined threshold value M.
